(19) United States
(12) Patent Application Publication
(10) Pub. No.: US 2026/0069079 A1
(43) Pub. Date: Mar. 12, 2026

(54) AIR FRYER

(71) Applicant: Ningbo Zhonghong Intelligent Technology Co., Ltd., Cixi (CN)

(72) Inventor: Qunhui YANG, Cixi (CN)

(73) Assignee: Ningbo Zhonghong Intelligent Technology Co., Ltd., Cixi (CN)

(21) Appl. No.: 18/903,017

(22) Filed: Oct. 1, 2024

(30) Foreign Application Priority Data
Sep. 6, 2024 (CN) 202411246156.8

(51) Int. Cl. A47J 37/06

(52) U.S. Cl. CPC A47J 37/0641

(57) ABSTRACT

An air fryer is provided. The air fryer includes a fryer body, frying baskets and at least one heating assembly connected inside the fryer body; the fryer body includes at least one cooking compartment and insertion openings which are in communication with the cooking compartments and provided for the frying baskets to be pushed into or pulled out of the cooking compartments; each heating assembly includes an electric heating element and a fan assembly; the fan assembly is connected at a side of the fryer body away from the insertion opening and communicated with the cooking compartment; the fan assembly has an air outlet channel, and an air outlet in communication with the top of the cooking compartment is disposed on the air outlet channel; the electric heating element is connected at the top of the cooking compartment and disposed corresponding to the air outlet.

### CROSS-REFERENCE TO THE RELATED APPLICATIONS

This application is based upon and claims priority to Chinese Patent Application No. 202411246156.8, filed on Sep. 6, 2024, the entire contents of which are incorporated herein by reference.

### TECHNICAL FIELD

The present disclosure relates to the technical field of kitchen appliances and in particular to an air fryer.

### BACKGROUND

The air fryers are cooking devices which can heat an airflow rapidly with a heating element and enable the heated air flow to contact with foods by using a large-power fan so as to achieve frying effect on the foods. Because the foods prepared by the air fryers feature good taste, less oil and less harmful substances, the air fryers become very popular with the people. Therefore, the air fryers have been gradually accepted by common families and hence brought much convenience to the lives of the people.

In the related arts, the air fryers may comprise single-basket air fryers and double-basket air fryers. The single-basket air fryers have only one heating assembly. In contrast, the double-basket air fryers, especially those double-basket air fryers with up-down double stack design usually have two heating assemblies, and each heating assembly comprises an electric heating element and a fan. The electric heating element is usually an electric heating wire or electric heating tube. The fan is used to blow the heat generated by the electric heating element to a liner or a food cooking compartment to bake the foods. In the related arts, for the air fryers, especially for the double-basket air fryers, in order to expand the space of the cooking compartment, the heating assembly is usually disposed at a back side of the air fryers or at a side away from a user, and the hot air blown out by the fan runs through an air outlet channel into the cooking compartment. Specifically, the air outlet channel is vertically disposed at a back side of the cooking compartment, and an upper end of the air outlet channel is in communication with the top of the cooking compartment. In this case, the fan blows up the hot airflow generated around the heating element through the air outlet channel to the top of the cooking compartment, and the hot airflow moves down from the top of the cooking compartment so as to bake the foods in the cooking compartment as the double-basket air fryer disclosed in the patent application with the publication number CN117562428A.

In the related arts, the air fryers have the following shortcomings during practical applications: the electric heating element and the fan of the heating assembly are both disposed at the back side of the cooking compartment or at the side of the air fryers away from the user, and the fan blows up the hot airflow generated by the electric heating element through the air outlet channel to the top of the cooking compartment, and then the hot airflow moves down from the top of the cooking compartment to the surfaces of the foods. In this way, the transmission time of the hot airflow is longer and the energy loss is larger. In other words, the hot airflow takes a longer time to reach the surfaces of the foods from its generation due to longer heat transmission path, resulting in higher energy loss. Therefore, the air fryers in the related arts have low baking efficiency and produce poor taste for the baked foods.

### SUMMARY

In order to address the above shortcomings in the prior arts, the present disclosure provides an air fryer capable of reducing energy loss in transmission process of heat to improve the baking efficiency while providing good food tastes.

The technical solution of the present disclosure is to provide an air fryer with the following structure, which comprises a fryer body, frying baskets and at least one heating assembly connected inside the fryer body. The fryer body comprises at least one cooking compartment and insertion openings which are in communication with the cooking compartments and provided for the frying baskets to be pushed into or pulled out of the cooking compartments. Each heating assembly comprises an electric heating element and a fan assembly. The fan assembly is connected at a side of the fryer body away from the insertion opening and communicated with the cooking compartment. The fan assembly has an air outlet channel, and an air outlet in communication with the top of the cooking compartment is disposed on the air outlet channel. The electric heating element is connected at the top of the cooking compartment and disposed corresponding to the air outlet such that an airflow from the air outlet is heated and the heated airflow is moved down into the cooking compartment.

In some embodiments, a flow guide hood in communication with the cooking compartment is connected at the top of the cooking compartment, an inner end of the flow guide hood is in communication with the air outlet, and the electric heating element is disposed inside the flow guide hood.

In some embodiments, an air inlet in communication with the air outlet is formed at the inner end of the flow guide hood, and a flow scattering plate is connected inside the air inlet to scatter the airflow entering the air inlet into the flow guide hood.

In some embodiments, the flow scattering plate is bent into wave shape and disposed along a width direction of the air inlet, and a flow guide channel for the airflow to enter the flow guide hood is formed between two bending parts in the flow scattering plate.

In some embodiments, the electric heating element is transversely disposed inside the flow guide hood, and a heat radiation plate attached to the top of the electric heating element is connected on the electric heating element.

In some embodiments, the heat radiation plate is disposed at a side of the electric heating element close to the air inlet, and a side of the electric heating element away from the air inlet is exposed out of the heat radiation plate.

In some embodiments, the flow guide hood is circumferentially connected with a downward-extending baffle plate and both ends of the baffle plate are respectively connected with both sides of the air inlet, and thus a flow guide chamber corresponding to the air inlet is enclosed with the baffle plate on the flow guide hood.

In some embodiments, the fan assembly comprises a motor connected with fryer body and wind blades disposed inside the air outlet channel and connected with a rotary shaft of the motor; a through hole in communication with the cooking compartment is disposed on a sidewall of the air outlet channel close to the cooking compartment; a mesh cover covered on the through hole is connected on an inner wall of the cooking compartment; the wind blades comprise two axially-spaced annular plates, and a plurality of arc-shaped vanes circumferentially distributed are connected between the two annular plates.

In some embodiments, there are two cooking compartments which are sequentially distributed along a height or width direction of the fryer body; there are two heating assemblies which are disposed respectively corresponding to the two cooking compartments.

In some embodiments, a recess is disposed on the housing, and a control panel movable back and forth is rotatably connected in the recess.

In conclusion, compared with the related arts, the air fryer in the present disclosure has the following advantages: in the air fryer, the electric heating element and the fan assembly of the heating assembly are separated. In other words, the fan assembly is disposed at the side of the fryer body away from the insertion opening and communicated with the cooking compartment; and the electric heating element is connected at the top of the cooking compartment and opposed to the air outlet of the air outlet channel of the fan assembly. The airflow generated by the fan assembly is blown out of the air outlet of the air outlet channel and then heated by the electric heating element at the time of going through the electric heating element. Under the action of the airflow, the heated airflow moves downward into the cooking compartment. In this way, the transmission path in which the hot airflow reaches the surfaces of the foods can be shortened and thus the hot airflow can reach the surfaces of the foods in a shorter time. In this case, the energy loss of the hot airflow in the entire transmission path is reduced. As a result, the air fryer can reduce the energy loss of the heat in the transmission process, improving the baking efficiency and producing good food tastes.

### BRIEF DESCRIPTION OF THE DRAWINGS

FIG. 1 is a structural schematic diagram illustrating an air fryer according to some embodiments of the present disclosure.

FIG. 2 is a schematic diagram illustrating a sectional structure of an air fryer according to some embodiments of the present disclosure.

FIG. 3 is a schematic diagram illustrating an interior structure of an air fryer according to some embodiments of the present disclosure.

FIG. 4 is a stereoscopic diagram illustrating a sectional structure of an air fryer according to some embodiments of the present disclosure.

FIG. 5 is a structural schematic diagram illustrating a flow guide hood of an air fryer according to some embodiments of the present disclosure.

FIG. 6 is a structural schematic diagram of a flow guide hood of another angle of an air fryer according to some embodiments of the present disclosure.

FIG. 7 is a schematic diagram illustrating an assembling structure of a flow guide hood of an air fryer according to some embodiments of the present disclosure.

FIG. 8 is a schematic diagram illustrating an assembling structure of a flow guide hood of another angle of an air fryer according to some embodiments of the present disclosure.

FIG. 9 is a schematic diagram illustrating a sectional structure of a flow guide hood of an air fryer according to some embodiments of the present disclosure.

FIG. 10 is a structural schematic diagram illustrating wind blades of a fan assembly of an air fryer according to some embodiments of the present disclosure.

Numerals of the drawings are described below:
1. fryer body, 100. cooking compartment, 101. insertion opening, 102. recess, 103. liner, 2. frying basket, 3. heating assembly, 300. electric heating element, 301. fan assembly, 302. motor, 303. wind blade, 304. through hole, 305. mesh cover, 307. vane, 4. air outlet channel, 400. air outlet, 5. flow guide hood, 500. air inlet, 501. top plate, 502. bottom plate, 503. baffle plate, 504. air blocking part, 505. flow scattering plate, 506. flow guide channel, 507. heat radiation plate, and 6. control panel.

### DETAILED DESCRIPTION OF THE EMBODIMENTS

The present disclosure will be further detailed below in combination with drawings and specific embodiments.

In the descriptions of embodiments of the present disclosure, it is understood that the orientation or positional relationship indicated by the terms such as “longitudinal”, “transverse”, “width”, “thickness”, “upper”, “lower”, “front”, “rear”, “vertical”, “top” and “bottom” and the like is based on the orientation or positional relationship shown in the drawings and used only for ease of descriptions and simplification of descriptions and does not indicate or imply that the indicated devices or elements must have a particular orientation, or be constructed or operated in a particular orientation. Therefore, such terms shall not be understood as limiting of the present disclosure.

Furthermore, the terms “first” and “second” are used for descriptions only and shall not be understood as indicating or implying relative importance or implicitly indicating the number of the indicated features. As a result, the features defined by “first” and “second” may explicitly or implicitly include one or more of the features. In the descriptions of the present disclosure, the “several”refers to two or more, unless otherwise clearly stated.

In the present disclosure, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or direct connection or indirect connection through an intermediate medium, or may be internal communication between two elements. Those skilled in the art may understand the specific meanings of the above terms in the present disclosure according to actual situations.

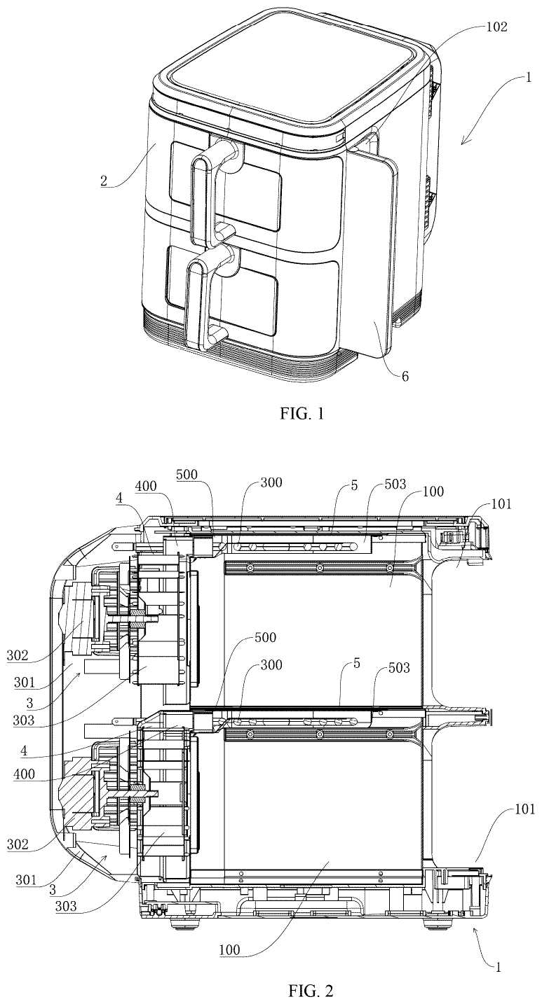

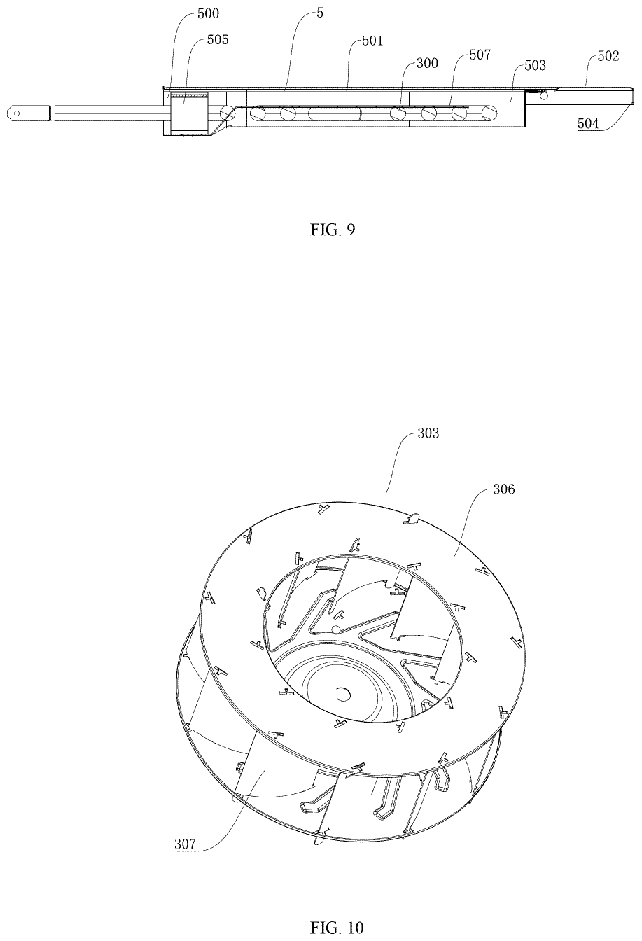

As shown in FIGS. 1 to 10, an embodiment of the present disclosure provides an air fryer, which structurally comprises a fryer body 1 and frying baskets 2. The fryer body 1 comprises a housing, an electric control unit connected to the housing, a control panel 6, and a liner 103 connected in the housing. The fryer body 1 comprises at least one cooking compartment 100, and the cooking compartments 100 are formed in the liner 103. Insertion openings 101 which are in communication with respective cooking compartments 100 and provided for the frying baskets 2 to be pushed into or pulled out of the cooking compartments 100 are disposed at a user side of the fryer body 1, and the insertion openings 101 match in number with the cooking compartments 100. At least one heating assembly 3 corresponding to the cooking compartments 100 is connected in the fryer body 1, namely, one cooking compartment 100 corresponds to one heating assembly 3.

In this embodiment, each heating assembly 3 comprises an electric heating element 300 and a fan assembly 301. As shown in FIGS. 2, 3 and 4, the fan assembly 301 is connected at a side of the fryer body 1 away from the insertion opening 101, and communicated with the cooking compartment 100. In other words, the fan assembly 301 is connected at a back side of the fryer body 1 or at a side away from the user, or the side where the insertion opening 101 of the fryer body 1 is located is opposed to the side where the fan assembly 301 of the fryer body 1 is located. The fan assembly 301 has an upward-extending air outlet channel 4, and an air outlet 400 in communication with the top of the cooking compartment 100 is disposed on the air outlet channel 4. Furthermore, the electric heating element 300 is separated from the fan assembly 301 and connected at the top of the cooking compartment 100 and also opposed to the air outlet 400. The electric heating element 300 is used to heat an airflow coming out of the air outlet 400 and move the heated airflow downward into the cooking compartment 100.

Furthermore, in this embodiment, the control panel 6 controls the electric heating element 300 to generate heat and controls the fan assembly 301 to generate an airflow which moves up the air outlet channel 4 and out of the air outlet 400; the airflow blown out of the air outlet 400 is heated by the electric heating element 300 to form a hot airflow; the hot airflow moves downward into the cooking compartment and to the surfaces of the foods under the action of the airflow of the fan assembly 301; at the same time, the heat in the cooking compartment 100 is sucked by the fan assembly 301 again. Therefore, a hot airflow circulation is formed in the cooking compartment 100, so as to perform cyclic heating baking on the foods.

Furthermore, in this embodiment, in the air fryer, the electric heating element 300 and the fan assembly 301 of the heating assembly 3 are separated. In other words, the fan assembly 301 is disposed at the side of the fryer body 1 away from the insertion opening 101 and communicated with the cooking compartment 100; and the electric heating element 300 is connected at the top of the cooking compartment 100 and opposed to the air outlet 400 of the air outlet channel 4 of the fan assembly 301. The airflow generated by the fan assembly 301 is blown out of the air outlet 400 of the air outlet channel 4 and then heated by the electric heating element 300 at the time of going through the electric heating element 300. Under the action of the airflow, the heated airflow moves downward into the cooking compartment 100. In this way, the transmission path in which the hot airflow reaches the surfaces of the foods can be shortened and thus the hot airflow can reach the surfaces of the foods in a shorter time. In this case, the energy loss of the hot airflow in the entire transmission path is reduced. As a result, the air fryer can reduce the energy loss of the heat in the transmission process, improving the baking efficiency and producing good food tastes.

Illustratively, in the related arts, the fan assembly conveys the hot airflow generated by the electric heating element to the top of the cooking compartment through the air outlet channel, and then the hot airflow moves from the top of the cooking compartment into the cooking compartment. In this embodiment, under the action of the airflow of the fan assembly 301, the hot airflow generated by the electric heating element 300 directly moves down into the cooking compartment rather than through the air outlet channel 4, so as to reach the surfaces of the foods and bake the foods. Therefore, compared with the air fryer in the related arts, the transmission path in which the hot airflow generated by the electric heating element 300 reaches the surfaces of the foods in the cooking compartment 100 can be shortened at least by half, and the transmission time of the hot airflow can be saved at least by half.

It can be easily understood that the electric heating element 300 is an electric heating wire or an electric heating tube, which is electrically connected with the electric control unit of the air fryer and can generate heat when powered on. Further, the airflow can be heated quickly when running through the electric heating element 300 and be formed into a hot airflow under the action of the airflow.

In this embodiment, the fan assembly 301 comprises a motor 302 connected with the fryer body 1 and wind blades 303 disposed inside the air outlet channel 4 and connected with a rotary shaft of the motor 302. A through hole 304 in communication with the cooking compartment 100 is disposed on a sidewall of the air outlet channel 4 close to the cooking compartment 100. A mesh cover 305 covered on the through hole 304 is connected on an inner wall of the cooking compartment 100. Specifically, the air outlet channel 4 is located between the motor 302 and the cooking compartment 100. The air outlet channel 4 comprises vertically-disposed first plate piece and second plate piece. As shown in FIG. 4, the second plate piece is located at a side close to the cooking compartment 100, and a space between the first plate piece and the second plate piece is formed into the upward-extending air outlet channel 4. The wind blades 303 of the fan assembly 301 are located inside the air outlet channel 4. The through hole 304 in communication with the cooking compartment 100 is disposed on the second plate piece. Under the action of the rotation of the wind blades 303, the air or hot airflow in the cooking compartment 100 is sucked into the air outlet channel 4, and under the action of the wind blades 303, the air or hot airflow runs up through the air outlet channel 4 and then out of the air outlet 400. It can be easily understood that a lower end of the air outlet channel 4 is a closed end, which ensures the airflow in the air outlet channel 4 can run up fast, improving the baking efficiency.

Furthermore, in this embodiment, the wind blades 303 of the fan assembly 301 are axial flow wind blades 303 with its center aimed at the through hole 304 on the sidewall of the air outlet channel 4. It can be easily understood that a hole matching the through hole 304 on the air outlet channel 4 is opened on a back side of the liner 103 of the air fryer or the through hole 304 on the air outlet channel 4 and the hole on the back side of the liner 103 of the air fryer are the same one or share one through hole 304. The mesh cover 305 is covered on the through hole 304 to prevent foods from entering the fan assembly 301.

Illustratively, as shown in FIGS. 4 and 10, the wind blades 303 comprise two axially-spaced annular plates 306, and a plurality of arc-shaped vanes 307 distributed circumferentially are connected between the two annular plates 306. A central hole of the annular plate close to the cooking compartment shares the same axis with the through hole 304, whereas a central hole of the annular plate away from the cooking compartment is connected with the rotary shaft of the motor 302. The wind blades 303 can produce larger and stronger air at the same rotation speed as the fans in the prior arts so as to increase the airflow volume and airflow rate and improve the baking efficiency.

It can be understood that the frying basket 2 in this embodiment comprises a panel connected at the insertion opening 101, a food basket connected at an inner side of the panel to hold foods and a handle mounted on an outer sidewall of the panel. A transparent window may be connected on the panel. An outward-turning edge is disposed respectively at both sides of the top of the food basket, and a pair of insertion grooves extending along a depth direction of the cooking compartments 100 is disposed on two opposed inner sidewalls of each cooking compartment 100. The turning edges at both sides of the frying basket 2 may be slidably inserted into the pair of insertion grooves. A plurality of vent holes are disposed at the back side of the food basket and located close to a lower part of the back side of the food basket. In this way, the heat can run through the foods and make the foods at the bottom of the food basket easier to cook, thereby improving the baking efficiency.

It can be easily understood that the fan assembly 301 is mounted at the back side of the fryer body 1 and the airflow generated by the fan assembly 301 is blown to the top of the cooking compartment 100 through the air outlet channel 4 and the air outlet 400. An area closer to the fan assembly 301 at the top of the cooking compartment 100 has a larger air pressure and a faster air speed, whereas an area farther away from the fan assembly 301 has a smaller air pressure and a smaller air speed. In this case, the hot airflow heated by the electric heating element has different levels of heat or heat energy at the back and front of the cooking compartment 100, thus affecting the baking effect and efficiency for the foods. For this reason, in this embodiment, as shown in FIGS. 2, 3 and 4, a flow guide hood 5 in communication with the cooking compartment 100 is connected at the top of the cooking compartment 100. The flow guide hood 5 extends from inside to outside along the depth direction of the cooking compartment 100, and an inner end of the flow guide hood 5 is in communication with the air outlet 400. The electric heating element 300 is disposed inside the flow guide hood 5. The flow guide hood 5 is a flat component independent of the cooking compartment 100 and disposed at the top of the cooking compartment 100 to achieve quick gathering effect on the airflow generated by the fan assembly 301, so as to increase the entire airflow pressure. In this case, the electric heating element 300 can quickly heat the airflow gathered in the flow guide hood 5 so as to improve the airflow heating efficiency. Furthermore, the hot airflow in the flow guide hood 5 moves down to the surfaces of the foods quickly and uniformly, thereby improving the baking efficiency.

At the inner end of the flow guide hood 5, an air inlet 500 in communication with the air outlet 400 is formed. It can be easily understood that the airflow blown from the air outlet 400 to the air inlet 500 of the flow guide hood 5 can, under the action of the air pressure, be gathered and quickly moved into the flow guide hood 5. In this case, the electric heating element 300 cannot uniformly heat the airflow, such that the hot airflow entering the cooking compartment 100 has no uniform temperature, affecting the baking effect. Therefore, in this embodiment, as shown in FIGS. 2, 4 and 5, a flow scattering plate 505 is connected in the air inlet 500 to scatter the airflow entering the air inlet 500 into the flow guide hood 5. The disposal of the flow scattering plate 505 can scatter the gathered airflow entering the air inlet 500 into several airflows and guide them into the flow guide hood 5. In this way, the airflows can be in full and uniform contact with the electric heating element 300, which improves the airflow heating efficiency and makes the airflows entering the cooking compartment 100 heated uniformly, thereby improving the baking effect and avoiding burning a part of the foods.

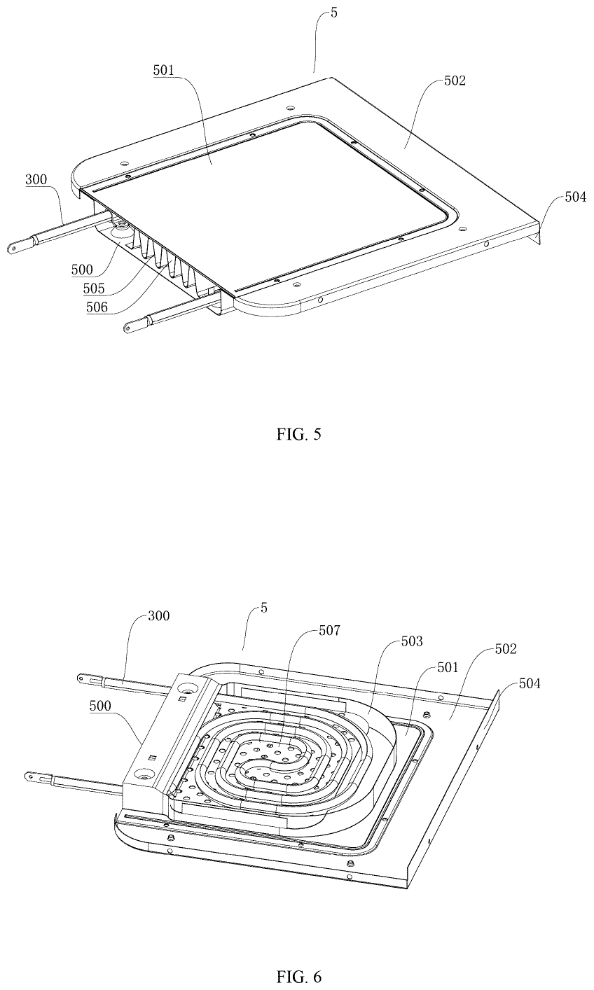

Illustratively, as shown in FIGS. 5, 7 and 8, the flow scattering plate 505 is formed by bending one plate into wave-like shape and disposed along a width direction of the air inlet 500. A flow guide channel 506 for the airflow to enter the flow guide hood 5 is formed between two adjacent bending parts in the flow scattering plate 505. Compared with the flow guide grating formed by punching in the prior arts, the flow scattering plate 505 can form more flow guide channels 506 so as to scatter the airflow into more smaller airflows, making the airflows be in full contact with the electric heating element 300.

In other embodiments, the flow scattering plate 505 may also be another structure, for example, a plurality of spaced flow guide sheets are vertically connected at the air inlet 500 and a flow guide channel is formed between adjacent flow guide sheets.

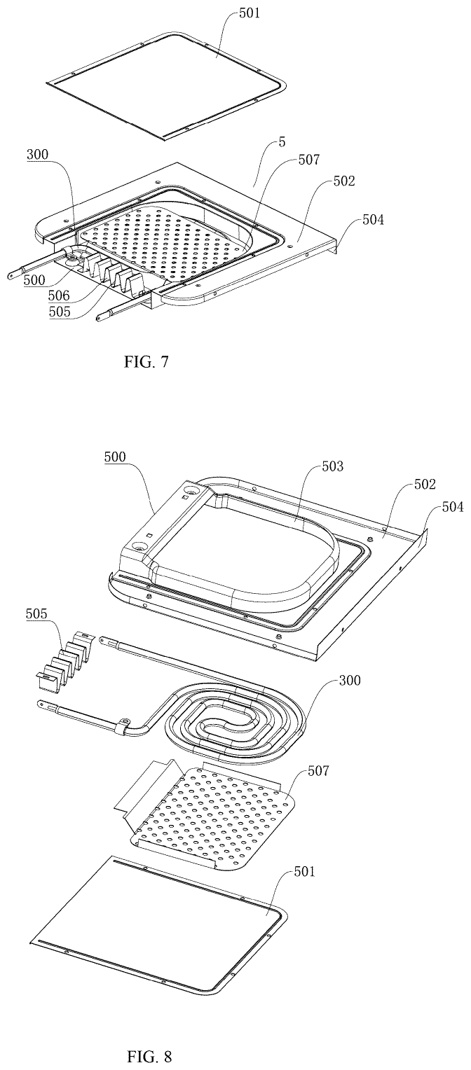

It can be easily understood that in this embodiment, the electric heating element 300 is transversely disposed in the flow guide hood 5, and the air inlet 500 is located at a side of the electric heating element 300. The position closer to the air inlet 500 in the flow guide hood 5 has a faster airflow speed and a higher air pressure, whereas the position farther away from the air inlet 500 has a slower airflow speed and a smaller air pressure. When the electric heating element 300 generates heat, the area close to the air inlet 500 has a fast heat radiation speed and the area away from the air inlet 500 has a slow heat radiation speed. In this case, the electric heating element 300 generates non-uniform heat, such that the hot airflow entering the cooking compartment has different temperatures at the front and back of the cooking compartment. Therefore, in this embodiment, as shown in FIGS. 7, 8 and 9, a heat radiation plate 507 attached to the top of the electric heating element 300 is connected on the electric heating element 300, and the heat radiation plate 507 is connected at a side of the electric heating element 300 close to the air inlet 500. In other words, the heat radiation plate 507 may not fully cover the electric heating plate 300 but only cover the side of the electric heating element 300 close to the air inlet 500. Thus, a side of the electric heating element 300 away from the air inlet 500 is exposed out of the heat radiation plate 507. With the disposal of the heat radiation plate 507, the heat of the electric heating element 300 can be quickly transferred to the heat radiation plate 507 so as to speed up the heat radiation of the electric heating element 300 and thus make the entire heat of the electric heating element 300 radiated uniformly. In this way, the defects of the heat centralization and slow heat radiation of the electric heating element 300 can be avoided, thus improving the baking effect.

Illustratively, as shown in FIG. 7, the heat radiation plate 507 is matched in shape with the interior of the flow guide hood 5, and is connected by screws at the side of the electric heating element 300 close to the air inlet 500. A plurality of heat radiation holes are disposed uniformly on the heat radiation plate 507.

Furthermore, in this embodiment, the flow guide hood 5 is circumferentially connected with a downward-extending baffle plate 501 and both ends of the baffle plate 501 are respectively connected with both sides of the air inlet 500, and thus a flow guide chamber corresponding to the air inlet 500 is enclosed with the baffle plate 501 on the flow guide hood 5. The electric heating element 300 and the heat radiation plate 507 are both disposed inside the flow guide chamber. Specifically, the flow guide hood 5 comprises a top plate 501 and a bottom plate 502 connected at the top plate 501 or at the bottom of the top plate 501. The baffle plate 503 is connected on the bottom plate 502 and the air inlet 500 is disposed on the bottom plate 502. As shown in FIGS. 5, 6 and 7, an end of the baffle plate 503 away from the fan assembly 301 is disposed as an arc-shaped closed end. In this case, the airflow from the air outlet 400 of the air outlet channel 4 firstly enters the flow guide hood 5 instead of directly entering the cooking compartment 100. The airflow is gathered in the flow guide hood 5 and also heated by the electric heating element 300. The generated hot airflow, under the action of the fan assembly 3, uniformly moves from top down into the cooking compartment 100. Hence, non-uniform cooking on the foods resulting from the inconsistent flow rate or air pressure of the hot airflow entering the cooking compartment 100 can be avoided effectively, thereby overcoming the defects of long baking time and poor taste. Furthermore, the closed end of the baffle plate 503 is disposed as arc-shape. After the airflow from the air outlet 400 enters the flow guide chamber of the flow guide hood 5, the hot airflow can generate vortex or eddy current in the flow guide chamber so as to be in full contact with the electric heating element 300 for heating. In addition, the air pressure can be increased, which increases the down-moving speed of the hot airflow.

Furthermore, in this embodiment, as shown in FIGS. 6 and 7, an air blocking part 504 bending down and extending is disposed at a side of the bottom plate 502 close to the insertion opening 101. The disposal of the air blocking part 504 can achieve the effect of gathering heat and preventing the hot airflow blowing toward the insertion opening 101 such that the hot airflow can quickly move down to the surfaces of the foods.

In order to enable the airflow from the air outlet 400 of the air outlet channel 4 to quickly enter the flow guide hood 5, as shown in FIGS. 2 and 4, the inner end of the flow guide hood 5 or the air inlet 500 of the flow guide hood 5 is disposed as outer-wide and inner-narrow. Hence, the airflow from the air outlet 400 can quickly enter the flow guide hood 5.

By referring to FIGS. 1 to 4 again, in this embodiment, the air fryer is a double-basket air fryer. Specifically, there are two cooking compartments 100 which are distributed sequentially along a height direction of the liner 103; there are two frying baskets which are respectively connected in the two cooking compartments 100 through the insertion openings 101. Furthermore, there are two heating assemblies 3 which are respectively disposed corresponding to the two cooking compartments 100. Each heating assembly 3 comprises a fan assembly 301 at the back side of the cooking compartment 100 and an electric heating element 300 at the top of or above the cooking compartment 100. In the embodiment of the double-basket air fryer, the flow guide hood 5 located above is connected with the top of the liner 103, and the flow guide hood 5 located below is connected to a bottom of a middle transverse partition plate in a middle part of the liner 103. Further, the flow guide hood 5 located below divides the liner 103 into upper and lower independent cooking compartments 100, avoiding taste interference between the foods in the two cooking compartments 100.

In other embodiments, there may also be three or four cooking compartments 100 and so on, which are distributed along the height direction of the fryer body 1. Similarly, in other embodiments, the cooking compartments 100 may also be distributed sequentially along a width direction of the dryer body 1 and thus the fryer body 1 has a single-layer multi-compartment structure. In other embodiments, the air fryer may also be a single-basket air fryer, or a three-basket air fryer. For the single-basket air fryer, there is only one cooking compartment 100, one frying basket 2, one heating assembly 3 and the like. In contrast, the three-basket air fryer may correspond to three cooking compartments 100, three frying baskets 2 and three heating assemblies 3 or two heating assemblies 3 or the like.

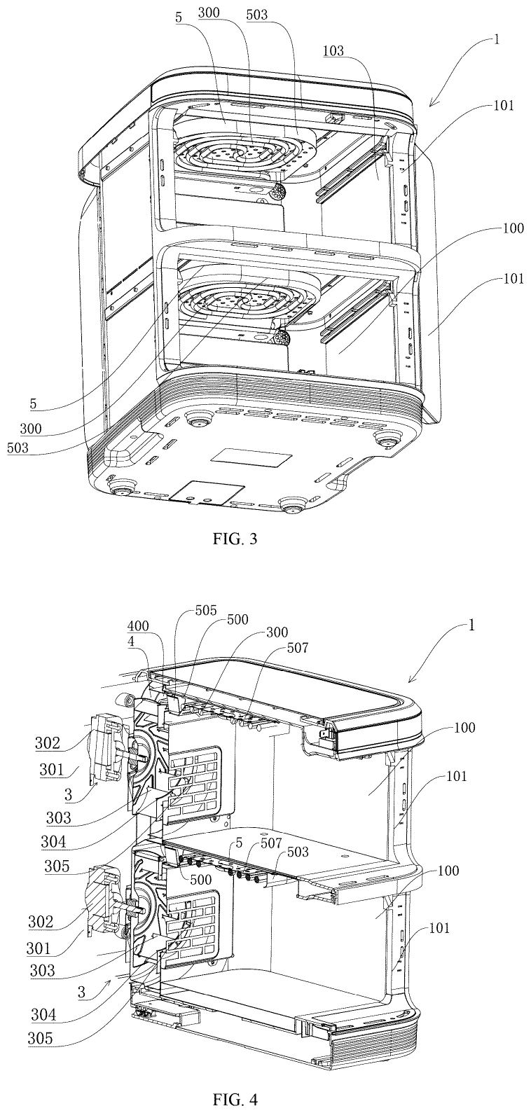

In some embodiments, as shown in FIG. 1 and FIG. 3, a recess 102 is disposed at an outer sidewall of the fryer body 1, and a control panel 6 movable back and forth is rotatably connected in the recess 102. In this case, the control panel 6 can rotatably protrude out of the recess 102 during use and retract or fold into the recess 102 after use. With this disposal, the user can easily operate it at different angles and the space in the housing can be further saved. At the time of use, the control panel may be unfolded while kept away from heat sources to help dissipate heat.

In the descriptions of the present disclosure, the descriptions made by referring to the terms “one embodiment”, “some embodiments” “an example”, “specific example” or “some examples” or the like mean that the specific features, structures, materials or characteristics described in combination with this embodiment or example are incorporated in at least one embodiment or example of the present disclosure. In this specification, the illustrative expressions of the above terms are not necessarily directed to same embodiment or example. Furthermore, the described specific features, structures, materials or characteristics may be combined in an appropriate way in one or more embodiments or examples.

The above descriptions are only about the specific embodiments of the present disclosure but the scope of protection of the present disclosure is not limited hereto. All changes or substitutions those skilled in the arts can easily conceive of within the technical scope of the present disclosure shall fall within the scope of protection of the present disclosure. Therefore, the scope of protection of the present disclosure shall be indicated by the claims.

1. An air fryer, comprising a fryer body, frying baskets and at least one heating assembly connected inside the fryer body;
wherein the fryer body comprises at least one cooking compartment and insertion openings, wherein the insertion openings are in communication with the cooking compartments and provided for the frying baskets to be pushed into or pulled out of the cooking compartments;
each heating assembly comprises an electric heating element and a fan assembly;
the fan assembly is connected at a side of the fryer body away from the insertion opening and communicated with the cooking compartment;
the fan assembly has an air outlet channel, and an air outlet in communication with a top of the cooking compartment is disposed on the air outlet channel; and
the electric heating element is connected at the top of the cooking compartment and disposed corresponding to the air outlet, wherein an airflow from the air outlet is heated to obtain heated airflow, and the heated airflow is moved down into the cooking compartment.

2. The air fryer according to claim 1, wherein a flow guide hood in communication with the cooking compartment is connected at the top of the cooking compartment; and an inner end of the flow guide hood is in communication with the air outlet, and the electric heating element is disposed inside the flow guide hood.

3. The air fryer according to claim 2, wherein an air inlet in communication with the air outlet is formed at the inner end of the flow guide hood, and a flow scattering plate is connected inside the air inlet to scatter the airflow entering the air inlet into the flow guide hood.

4. The air fryer according to claim 3, wherein the flow scattering plate is bent into wave shape and disposed along a width direction of the air inlet, and a flow guide channel for the airflow to enter the flow guide hood is formed between two bending parts in the flow scattering plate.

5. The air fryer according to claim 3, wherein the electric heating element is transversely disposed inside the flow guide hood, and a heat radiation plate attached to a top of the electric heating element is connected on the electric heating element.

6. The air fryer according to claim 5, wherein the heat radiation plate is disposed at a side of the electric heating element adjacent to the air inlet, and a side of the electric heating element away from the air inlet is exposed out of the heat radiation plate.

7. The air fryer according to claim 3, wherein the flow guide hood is circumferentially connected with a downward-extending baffle plate and both ends of the downward-extending baffle plate are respectively connected with both sides of the air inlet, and a flow guide chamber corresponding to the air inlet is enclosed with the downward-extending baffle plate on the flow guide hood.

8. The air fryer according to claim 1, wherein the fan assembly comprises a motor connected with the fryer body and wind blades disposed inside the air outlet channel and connected with a rotary shaft of the motor;
a through hole in communication with the cooking compartment is disposed on a sidewall of the air outlet channel adjacent to the cooking compartment;
a mesh cover covered on the through hole is connected on an inner wall of the cooking compartment; and
the wind blades comprise two axially-spaced annular plates, and a plurality of arc-shaped vanes circumferentially distributed are connected between the two axially-spaced annular plates.

9. The air fryer according to claim 1, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.

10. The air fryer according to claim 1, wherein a recess is disposed on a housing, and a control panel movable back and forth is rotatably connected in the recess.

11. The air fryer according to claim 2, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.

12. The air fryer according to claim 3, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.

13. The air fryer according to claim 4, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.

14. The air fryer according to claim 5, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.

15. The air fryer according to claim 6, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.

16. The air fryer according to claim 7, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.

17. The air fryer according to claim 8, wherein there are two cooking compartments, wherein the two cooking compartments are sequentially distributed along a height or width direction of the fryer body; and there are two heating assemblies, wherein the two heating assemblies are disposed respectively corresponding to the two cooking compartments.
